(19) United States
(12) Patent Application Publication
(10) Pub. No.: US 2013/0288505 A1
(43) Pub. Date: Oct. 31, 2013

(54) ELECTRICAL CONNECTOR ASSEMBLY

(71) Applicants: CHIEN-MIN HUNG, New Taipei (TW); QI-XUAN HONG, New Taipei (TW); CHING-JOU CHEN, New Taipei (TW)

(72) Inventors: CHIEN-MIN HUNG, New Taipei (TW); QI-XUAN HONG, New Taipei (TW); CHING-JOU CHEN, New Taipei (TW)

(21) Appl. No.: 13/854,613

(22) Filed: Apr. 1, 2013

(30) Foreign Application Priority Data
Apr. 27, 2012 (TW) 101115110

(51) Int. Cl. H01R 13/629

(52) U.S. Cl. CPC H01R 13/629
USPC 439/342

(57) ABSTRACT

An electrical connector assembly for electronically connecting a chip to a circuit board includes an electrical connector and a cover. The electrical connector includes a flip cover, a control element, a main body, and a fixing element. The flip cover is rotatably connected to the fixing element through the control element. The main body and the fixing element are located on the circuit board, and the chip is located on the main body. The cover is removably mounted on the flip cover. When the flip cover and the control element are rotated to be opened relative to the main body, the control element is rotated relative to the fixing element and is engaged with the flip cover.

### BACKGROUND

1. Technical Field

The disclosure generally relates to electrical connector assemblies.

2. Description of the Related Art

During assembly of electronic devices, an automatic surface mounted technology (SMT) machine is used to grab an electrical connector by suction and transfer the electrical connector to a printed circuit board, and then, the electrical connector may be welded on the circuit board. A cover is attached to the electrical connector. The cover includes a smooth outer surface for the automatic SMT machine to grab by suction. However, the assembly process of the cover and the electrical connector is quite complicated, and if the cover and the electrical connector are not aligned, terminals of the electrical connector may be damaged by the cover. When the electrical connector needs to be tested, the cover must be removed; and the cover may be attached to the electrical connector after being tested. It is a tedious process.

Therefore, there is room for improvement within the art.

### BRIEF DESCRIPTION OF THE DRAWINGS

Many aspects of an exemplary electrical connector assembly can be better understood with reference to the following drawings. The components in the drawings are not necessarily drawn to scale, the emphasis instead being placed upon clearly illustrating the principles of the exemplary electrical connector assembly. Moreover, in the drawings, like reference numerals designate corresponding parts throughout the several views. Wherever possible, the same reference numbers are used throughout the drawings to refer to the same or like elements of an embodiment.

FIG. 1 is an exploded view of an electrical connector assembly, according to an exemplary embodiment.

FIG. 2 is similar to FIG. 1, but showing from another angle.

FIG. 3 is an assembled view of the electrical connector assembly shown in FIG. 1.

### DETAILED DESCRIPTION

Reference is now made to the drawings to describe various embodiments of the present disclosure in detail.

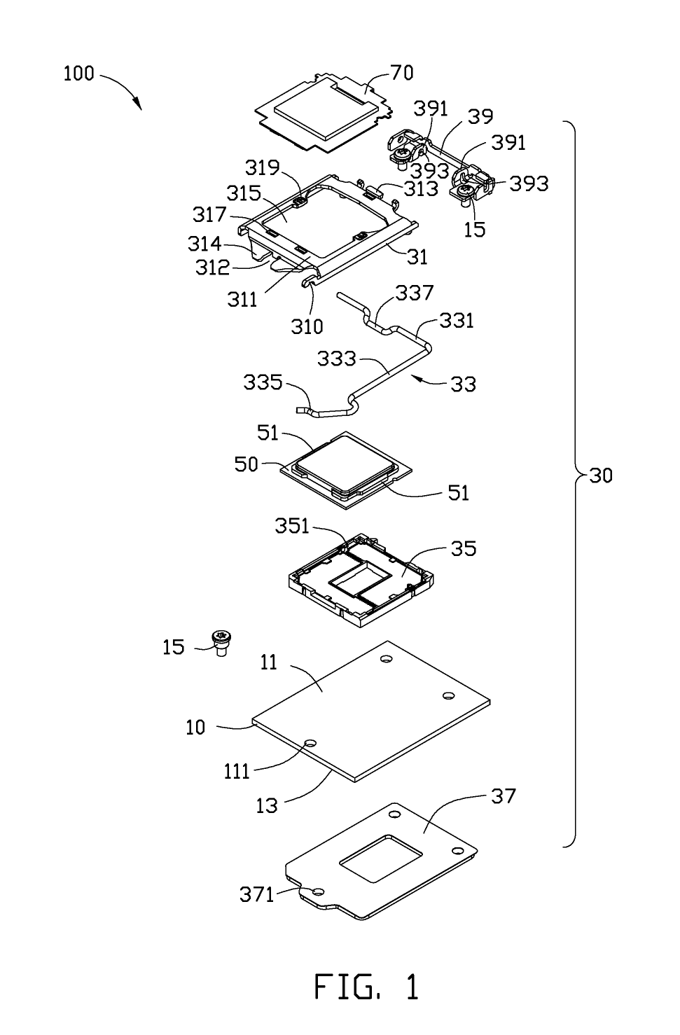

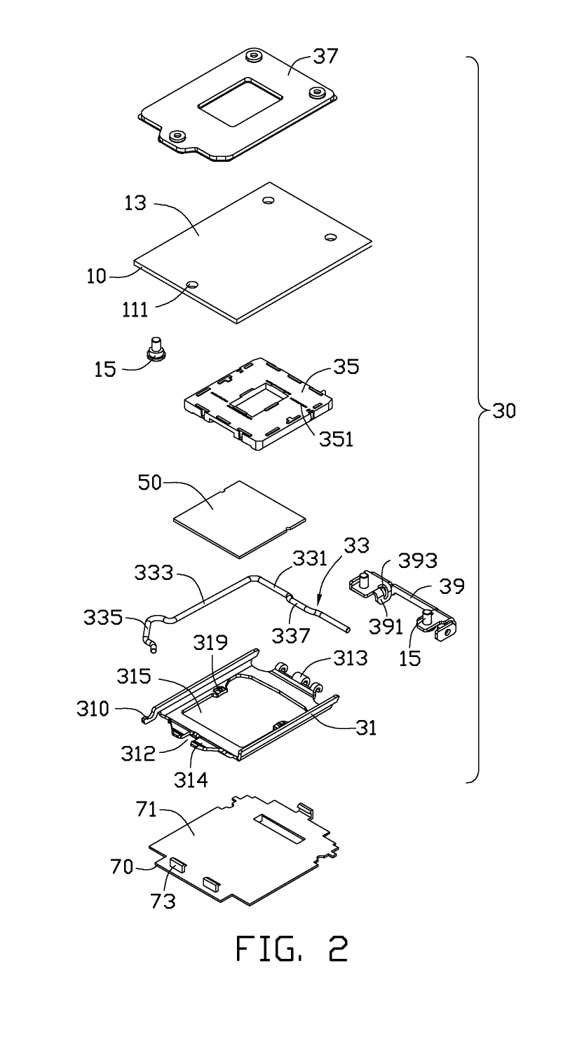

FIGS. 1 and 2 show an electrical connector assembly 100 for electronically connecting a chip 50 to a circuit board 10. The electrical connector assembly 100 includes an electrical connector 30 and a cover 70. The electrical connector 30 is mounted on the circuit board 10, and the chip 50 is electronically connected to the electrical connector 30. The cover 70 is mounted to the electrical connector 30.

The circuit board 10 includes a first surface 11 and a second surface 13. The first surface 11 defines a plurality of through holes 111 communicating with the second surface 13 for attaching the electrical connector 30 to the circuit board 10.

The electrical connector 30 includes a flip cover 31, a control element 33, a main body 35, a base plate 37 and a fixing element 39. The flip cover 31 is plate shaped and includes a substrate 311, and a barrel portion 313 extending from the substrate 311. The substrate 311 defines a receiving groove 315 and a plurality of recesses 317. A resisting portion 319 extends from each of two opposite inner sidewalls (not labeled) of the receiving groove 315. An engagement portion 310 away from the barrel portion 313 extends from the substrate 311. Two symmetrical extending portions 314 are formed at an edge of the substrate 311, and an opening 312 is defined between the two extending portions 314.

The control element 33 is substantially L-shaped, and includes a first shaft 331 and a second shaft 333 perpendicularly connected to the first shaft 331. A pivotal portion 337 projects from a middle of the first shaft 331, and the pivotal portion 337 is rotatably received in the barrel portion 313. A bent portion 335 is formed at a free end of the second shaft 333.

The main body 35 is located on the first surface 11 of the circuit board 10. A plurality of terminals 351 are located on the main body 35, and are electronically connected to the chip 50. The base plate 37 is located on the second surface 13 of the circuit board 10. The base plate 37 defines a plurality of apertures 371 corresponding to the plurality of through holes 111.

The fixing element 39 includes two fixing portions 391 spaced from each other. Each fixing portion 391 defines a guide hole 393. The first shaft 331 is rotatably connected to the fixing element 39 through the guide holes 393. The base plate 37 and the fixing element 39 are assembled to the circuit board 10 by fasteners 15 (e.g. screws). The fixing element 39 is located on the first surface 11 of the circuit board 10 and the circuit board 10 is located between the base plate 37 and the fixing element 39.

A protruding portion 51 protrudes from each of two opposite sides of the chip 50. Each protruding portion 51 resists a corresponding resisting portion 319.

A surface 71 of the cover 70 toward an inside direction has a plurality of latching portions 73 located thereon. Each latching portion 73 engages with one recess 317.

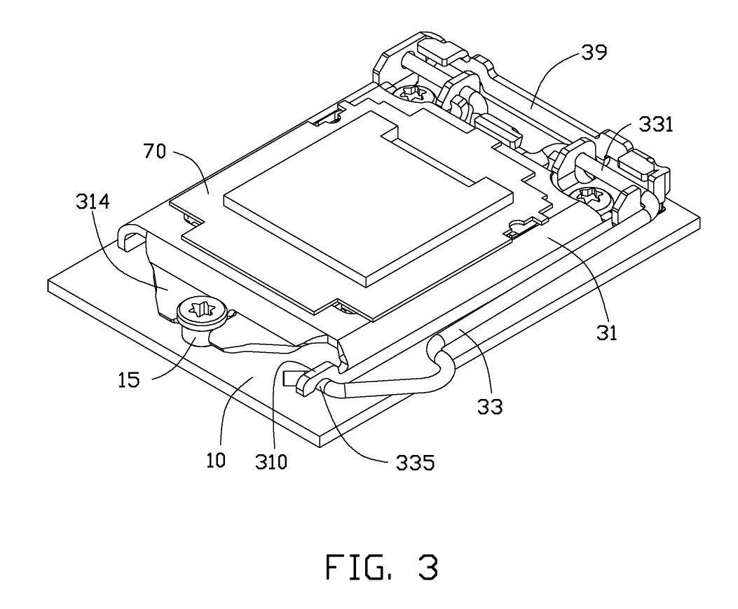

FIG. 3 shows the electrical connector assembly 100 is assembled as follows:

The main body 35 is electronically connected to the circuit board 10 through the plurality of terminals 351. The fixing element 39 is fixed on the first surface 11 and the base plate 37 is fixed on the second surface 13 by the fasteners 15. The barrel portion 313 is located between the two fixing portion 391. Two ends of the first shaft 331 are respectively received in the guide holes 393, and the pivotal portion 337 is rotatably received in the barrel portion 313. Then, the flip cover 31 is rotatably connected to the fixing element 39. Each of the latching portions 73 is engaged in a corresponding recess 317, and then the cover 70 is fixed on the flip cover 31.

The flip cover 31 and the control element 33 are rotated to be opened relative to the main body 35, and the chip 50 is located on the main body 35. The chip 50 is electronically connected to the circuit board 10 through the plurality of terminals 351. The flip cover 31 is rotated to allow the protruding portion 51 to resist the corresponding resisting portion 319 and the flip cover 31 is closed relative to the main body 35. The control element 33 is rotated to allow the bent portion 335 to engage with the engagement portion 310. A fastener 15 for fixing the base plate 37 is received in the opening 312.

The cover 70 is located on the flip cover 31, and the cover 70 is accurately aligned with the electrical connector 30. It is easy to assemble and the plurality of terminals 351 will not be damaged by the cover. Furthermore, the electrical connector 30 needs to be tested, the flip cover 31 is rotated to be opened relative to the main body 35 without removing the cover 70.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An electrical connector assembly for electronically connecting a chip to a circuit board, comprising:
an electrical connector comprising a flip cover, a control element, a main body, and a fixing element, the flip cover rotatably connected to the fixing element by the control element, the main body and the fixing element located on the circuit board, and the chip located on the main body; and
a cover removably mounted on the flip cover;
wherein when the flip cover and the control element are rotated to be opened relative to the main body, the control element is rotated relative to the fixing element and is engaged with the flip cover.

2. The electrical connector assembly as claimed in claim 1, wherein the flip cover comprises a substrate defining a plurality of recesses; a plurality of latching portions are located on the cover, and each latching portion engages with a corresponding recess.

3. The electrical connector assembly as claimed in claim 2, wherein a barrel portion extends from the substrate; the control element comprises a first shaft and a second shaft perpendicularly connected to the first shaft, a pivotal portion projects from middle of the first shaft, and the pivotal portion is rotatably received in the barrel portion.

4. The electrical connector assembly as claimed in claim 3, wherein an engagement portion away from the barrel portion extends from the substrate; the second shaft is engaged with the engagement portion.

5. The electrical connector assembly as claimed in claim 4, wherein the first surface of the substrate defines a receiving groove; a resisting portion extends from each of two opposite sidewalls of the receiving groove.

6. The electrical connector assembly as claimed in claim 5, wherein a protruding portion protrudes from each of two opposite sides of the chip; each protruding portion resists one of the two resisting portions.

7. The electrical connector assembly as claimed in claim 4, wherein a bent portion is formed at a free end of the second shaft, and the bent portion is engaged with the engagement portion.

8. The electrical connector assembly as claimed in claim 7, wherein a plurality of terminals are located on the main body and the chip is electronically connected to the circuit board through the plurality of terminals.

9. The electrical connector assembly as claimed in claim 8, wherein the fixing element comprises two fixing portions spaced from each other, each fixing portion defines a guide hole; the first shaft is rotatably connected to the fixing element through the guide holes.

10. An electrical connector assembly for electronically connecting a chip to a circuit board, comprising:
a flip cover defining a receiving groove;
a control element;
a main body located on the circuit board;
a fixing element, the flip cover rotatably connected to the fixing element through the control element; and
a cover;
wherein the cover is removably mounted on the flip cover and covers the receiving groove; when the flip cover and the control element are rotated to be closed relative to the main body, the control element is rotated relative to the fixing element and is engaged with the flip cover.

11. The electrical connector assembly as claimed in claim 10, wherein the flip cover comprises a substrate, the substrate defines a plurality of recesses; plurality of latching portions are located on the cover, and each latching portion engages with one recess.

12. The electrical connector assembly as claimed in claim 11, wherein a barrel portion extends from the substrate; the control element comprises a first shaft and a second shaft perpendicularly connected to the first shaft, a pivotal portion projects from middle of the first shaft, and the pivotal portion is rotatably received in the barrel portion.

13. The electrical connector assembly as claimed in claim 12, wherein an engagement portion away from the barrel portion extends from the substrate; the second shaft is engaged with the engagement portion.

14. The electrical connector assembly as claimed in claim 13, wherein a resisting portion extends from each of two opposite sidewalls of the receiving groove.

15. The electrical connector assembly as claimed in claim 14, wherein a protruding portion protrudes from each of two opposite sides of the chip; each protruding portion resists one of the two resisting portions.

16. The electrical connector assembly as claimed in claim 13, wherein a bent portion is formed at a free end of the second shaft, and the bent portion is engaged with the engagement portion.

17. The electrical connector assembly as claimed in claim 16, wherein a plurality of terminals are located on the main body and the chip is electronically connected to the circuit board through the plurality of terminals.

18. The electrical connector assembly as claimed in claim 17, wherein the fixing element comprises two fixing portions spaced from each other, each fixing portion defines a guide hole; the first shaft is rotatably connected to the fixing element through the guide holes.
